(19) United States
(12) Patent Application Publication
(10) Pub. No.: US 2009/0121565 A1
(43) Pub. Date: May 14, 2009

(54) Stator of Alternating-Current Rotary Electric Machine and Method of Insulating Stator Winding of Alternating-Current Rotary Electric Machine

(75) Inventors: Hirotatsu Ihara, Nagoya-shi (JP); Jun Fujiki, Echizen-shi (JP); Osamu Katou, Sakai-shi (JP)

Correspondence Address: OLIFF & BERRIDGE, PLC, P.O. BOX 320850, ALEXANDRIA, VA, 22320-4850, US

(73) Assignees: TOYOTA JIDOSHA KABUSHIKI KAISHA, TOYOTA-SHI (JP); NITTO SHINKO CORPORATION, SAKAI-SHI (JP)

(21) Appl. No.: 11/988,214

(22) PCT Filed: Jul. 13, 2006
(86) PCT No.: PCT/JP2006/314336

§ 371 Date: Jan. 3, 2008

(30) Foreign Application Priority Data
Jul. 14, 2005 (JP) 2005-205347

(51) Int. Cl. H01R 4/70; H02K 11/00

(52) U.S. Cl. 310/71; 174/138 F

(57) ABSTRACT

A neutral point terminal, which is formed by electrically connecting with each other a plurality of phases of coil windings included by an alternating-current rotary electric machine having the plurality of phases, is inserted into an insulating cover prefabricated into a bag shape to be fitted thereinto, and thereby insulated from the surroundings. As a result, an insulation distance of the neutral point terminal can be ensured by simple assembly work, while variations caused by the work can be reduced.

### TECHNICAL FIELD

The present invention relates to a stator of an alternating-current rotary electric machine and a method of insulating a stator winding of the alternating-current rotary electric machine, and more particularly to a technique of insulating a neutral point of an alternating-current rotary electric machine having a plurality of phases.

### BACKGROUND ART

A plurality of phases of stator windings, which are wound around a stator core of an alternating-current rotary electric machine having a plurality of phases, are generally swaged with a metal terminal (neutral point terminal) at a neutral point, and then enclosed in a bundle of the stator windings (coil end). The coil end in which the neutral point is enclosed is formed afterwards. Accordingly, the neutral point terminal assembled as such requires a structure that ensures insulation from the surroundings.

For example, Japan Institute of Invention and Innovation, Journal of Technical Disclosure No. 2004-503 402 (hereinafter referred to as “non-patent document 1”) discloses a structure that ensures insulation between the neutral point terminal and the coil end by covering a neutral point connecting portion (neutral point terminal) of a motor coil with an insulating tube, tape and others, and bending its end face to bring it into intimate contact with itself. According to the insulating structure, the neutral point terminal is entirely provided with an insulating coating in its circumferential direction and axial direction. Therefore, there is no need to provide a portion for ensuring an insulation distance (spatial distance, creepage distance) between the neutral point terminal and the coil at the insulating tube and others, which makes it possible to insulate the neutral point connecting portion in a small space. The coil end can thereby be downsized, which makes it possible to downsize the motor.

In the insulating structure for the neutral point connecting portion (neutral point terminal) disclosed in the document above, however, work of bending an end face of the insulating tube and others for covering the neutral point terminal, and bringing the end face into intimate contact with itself is required. Accordingly, assembly work becomes complicated.

For an alternating-current rotary electric machine used as a vehicle driving motor for a hybrid vehicle and others, in particular, the assembly work described above may be difficult owing to arrangement constraints (e.g. arrangement position, arrangement space) encountered when the alternating-current rotary electric machine is mounted on the vehicle.

Furthermore, when the alternating-current rotary electric machine is mounted on the vehicle, it is arranged under the environment affected by high temperature and vibrations. It is therefore necessary to ensure insulation in a more reliable manner when the neutral point terminal is assembled, by reducing variations caused by the assembly work. Therefore, in view of the arrangement constraints described above, the neutral point terminal of the alternating-current rotary electric machine serving as a vehicle driving motor requires an insulating structure, the assembly work of which is simple, and which has less variations in insulation (insulation distance) to be ensured.

### DISCLOSURE OF THE INVENTION

An object of the present invention is to reliably ensure an insulation distance by simple assembly work for a neutral point of an alternating-current rotary electric machine having a plurality of phases of stator windings.

A stator of an alternating-current rotary electric machine according to the present invention includes: a plurality of phases of stator windings; a neutral point terminal; and an insulating cover ensuring insulation of the neutral point terminal. The neutral point terminal is formed by electrically connecting one ends of the plurality of phases of the stator windings with each other. The insulating cover has an opening allowing the neutral point terminal to be inserted therethrough, and is formed of an insulator processed into a bag shape allowing the neutral point terminal inserted through the opening to be fitted thereinto.

In the above-described stator of the alternating-current rotary electric machine, insulation of the neutral point terminal can be ensured by relatively simple work of fitting the neutral point terminal into the insulating cover prefabricated into a bag shape, without any complicated work such as winding or bending of the insulator. Furthermore, the simple assembly work can reduce variations in insulation distance of the neutral point terminal, the insulation distance being ensured after the assembly work. Therefore, even if the alternating-current rotary electric machine is assembled in a space subject to arrangement constraints, it is possible to improve workability of the assembly work and ensure insulation of the neutral point after the assembly work.

Preferably, in the stator of the alternating-current rotary electric machine according to the present invention, a size and a shape of the insulating cover are designed such that a distance between the neutral point terminal in a fitted state and an end of the insulating cover is ensured to be at least a prescribed insulation distance.

In the above-described stator of the alternating-current rotary electric machine, the simple assembly work makes it possible to reduce variations in insulation distance, the variations being caused by manual work. It is therefore possible to allow the insulation distance ensured after the assembly work to approximately match with a design value determined by the size and the shape of the insulating cover. Accordingly, the size of the insulating cover can be designed as small as possible in accordance with a required insulation distance determined by JIS (Japanese Industrial Standard) and others, which makes it possible to reduce production cost of the insulating cover.

More preferably, in the stator of the alternating-current rotary electric machine according to the present invention, the insulating cover is formed by partially fastening a tube-like, self-welding insulating sheet to itself.

In the above-described stator of the alternating-current rotary electric machine, fastening points for forming a bag shape of the insulating cover can be formed easily by crimping the relevant portions. It is therefore possible to fabricate the insulating cover easily.

A method of insulating a stator winding of an alternating-current rotary electric machine according to the present invention is a method of insulating a plurality of phases of stator windings of a rotary electric machine, and includes the steps of: processing an insulator into a bag shape to fabricate an insulating cover; and inserting a neutral point terminal formed by electrically connecting one ends of the plurality of phases of the stator windings with each other, through an opening of the insulating cover, and fitting the inserted neutral point terminal thereinto for assembly.

In the above-described method of insulating the stator windings of the alternating-current rotary electric machine, insulation of the neutral point terminal can be ensured by relatively simple work of fitting the neutral point terminal in the insulating cover prefabricated into a bag shape, without any complicated work such as winding or bending of the insulator. Furthermore, the simple assembly work can reduce variations in insulation distance of the neutral point terminal, the insulation distance being ensured after the assembly work. Therefore, even if the alternating-current rotary electric machine is assembled in a space subject to arrangement constraints, it is possible to improve workability of the assembly work and ensure insulation of the neutral point after the assembly work.

Accordingly, the main advantage of the present invention is that an insulation distance for a neutral point of an alternating-current rotary electric machine having a plurality of phases of stator windings can be ensured reliably by a simple assembly work.

### BRIEF DESCRIPTION OF THE DRAWINGS

FIG. 1 is a block diagram for describing a configuration of a general drive system of an alternating-current rotary electric machine.

FIG. 2 is a schematic diagram for describing an example of an insulating cover used for insulating a neutral point of the alternating-current rotary electric machine according to an embodiment of the present invention.

FIG. 3 is a cross section for describing how a neutral point terminal is assembled to the insulating cover shown in FIG. 2.

FIG. 4 is a flowchart showing a process of assembly work for the neutral point of the alternating-current rotary electric machine according to the embodiment of the present invention.

FIG. 5 is a schematic diagram for describing another example of the insulating cover used for insulating the neutral point of the alternating-current rotary electric machine according to the embodiment of the present invention.

FIG. 6 is a block diagram showing an example of a configuration of a hybrid system mounted on a hybrid vehicle.

FIG. 7 is a schematic diagram showing an example of how main components of the hybrid system shown in FIG. 6 are arranged in a hybrid vehicle.

### BEST MODES FOR CARRYING OUT THE INVENTION

An embodiment of the present invention will hereinafter be described in detail with reference to the drawings. In the following, the same or corresponding parts in the drawings are denoted by the same reference characters, and the description thereof will not be repeated in principle.

FIG. 1 is a block diagram for describing a configuration of a general drive system of an alternating-current rotary electric machine.

Referring to FIG. 1, a motor drive system 5 includes a direct-current power supply 10, a three-phase inverter 20, and a three-phase AC (alternating-current) motor 30, which is shown as a typical example of an “alternating-current rotary electric machine”.

Direct-current power supply 10 is, for example, firmed of a secondary battery, a typical example of which is a lithium-ion secondary battery or a nickel metal hydride secondary battery.

Three-phase inverter 20 is formed to include a plurality of semiconductor switching devices for electric power, not shown, and converts an output voltage (direct-current voltage: DC voltage) of direct-current power supply 10 into a three-phase alternating-current voltage (AC voltage) to output the same. Direct-current power supply 10 may also be formed of a combination of a secondary battery and others and a DC/DC converter so that an output voltage of direct-current power supply 10 may be made variable according to the circumstances.

Three-phase AC motor 30 includes a U-phase coil winding 40u, a V-phase coil winding 40v, and a W-phase coil winding 40w, which are wound around a stator core (not shown). These phases of coil windings 40u, 40v, and 40w have one ends electrically connected with each other at a neutral point 50. As described above, during assembly work allowing three-phase AC motor 30 to be assembled to a housing, neutral point 50 is fixed such that insulation thereof from the surroundings is ensured by an insulating cover 100#. As such, a stator of three-phase AC motor 30 is formed to include the stator core (not shown), U-phase coil winding 40u, V-phase coil winding 40v, and W-phase coil winding 40w, neutral point 50, and insulating cover 100#.

U-phase coil winding 40u, V-phase coil winding 40v, and W-phase coil winding 40w have the other ends electrically connected to nodes that output these phases of (U-phase, V-phase, and W-phase) voltages of three-phase inverter 20, respectively. Accordingly, in accordance with a rotating magnetic field generated at the stator by applying three-phase AC voltage to each of the coil windings of three-phase AC motor 30, a rotor (not shown) is driven to rotate.

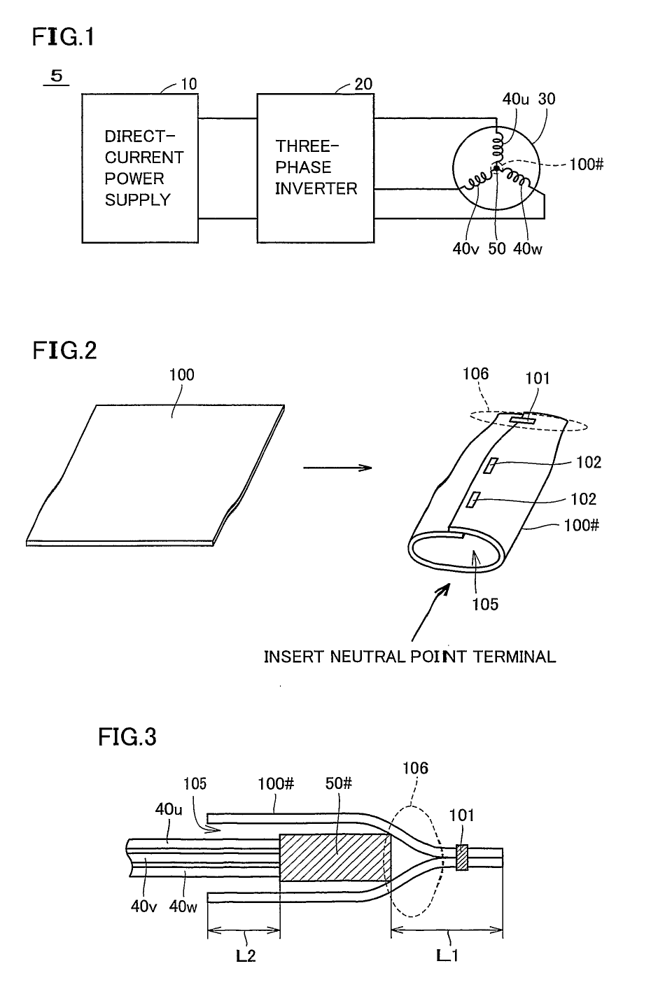

FIG. 2 is a schematic diagram for describing the insulating cover used for insulating the neutral point of the alternating-current rotary electric machine according to the embodiment of the present invention.

Referring to FIG. 2, a sheet-like insulator 100 (hereinafter also referred to as an insulating sheet 100) is formed into a tube, and fastening points 101, 102 are provided as appropriate, so that bag-shaped insulating cover 100# is formed. Insulating cover 100# has an opening 105 through which a neutral point terminal is inserted, and a bottom 106 formed by fastening point 101.

Any material can be used for insulating sheet 100, as long as insulating sheet 100 is an insulator that can be formed into a bag shape. In particular, if a self-welding sheet (a typical example of which is a self-welding silicon sheet) is used as insulating sheet 100, fastening points 101, 102 (FIG. 2) for forming a bag shape can easily be formed by crimping the relevant portions, which enables easy fabrication of insulating cover 100#. Fastening points 101, 102 may be provided as appropriate at a portion where the insulating sheet (self-welding sheet) is brought into contact with itself. Alternatively, fastening points may be provided all over the contact portion in a contiguous manner (i.e. in the entire area or on the entire side of the contact portion).

FIG. 3 shows a cross section for describing how neutral point terminal 50 is assembled to insulating cover 100# shown in FIG. 2.

Referring to FIG. 3, a neutral point terminal 50# is typically formed by swaging the ends of U-phase coil winding 40u, V-phase coil winding 40v, and W-phase coil winding 40w shown in FIG. 1 with a crimp-type terminal. Neutral point terminal 50# is inserted into bag-shaped insulating cover 100# through opening 105 until it abuts against bottom 106, to be fitted thereinto.

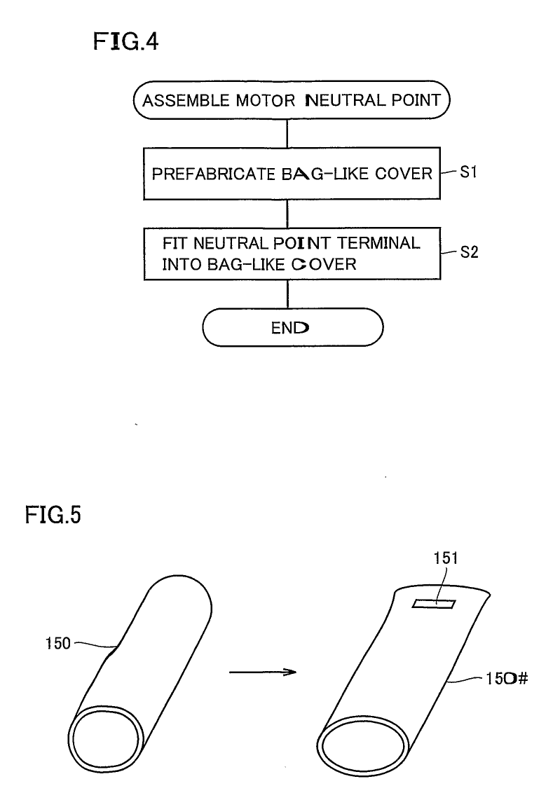

In other words, as shown in FIG. 4, the assembly work for the motor neutral point according to the embodiment of the present invention is conducted by prefabricating bag-shaped insulating cover 100# prior to the assembly work (step S1), and then inserting neutral point terminal 50# into bag-shaped insulating cover 100# to be fitted therein (step S2).

As described above, the assembly work for neutral point terminal 50# according to the embodiment of the present invention does not involve complicated work such as winding or bending of the insulating sheet, as in the non-patent document 1 described above. Instead, the assembly work can be relatively simple work of inserting neutral point terminal 50# into insulating cover 100# (i.e. fitting neutral point terminal 50# into insulating cover 100#) until it stops therein. Accordingly, workability during the assembly work is improved. Furthermore, it is also feasible to shift the assembly work from manually conducted one to automatically conducted one.

Furthermore, the easy assembly work can reduce variations in distances L1 and L2, i.e. insulation distances, between neutral point terminal 50# and each of the ends of insulating cover 100#, the distances being ensured after the assembly work, and the variations being caused by the assembly work. In other words, the insulation distance ensured after the assembly work is predominantly determined by the size and the shape of insulating cover 100# (a position of bottom 106), and thus the insulation of the neutral point according to the embodiment of the present invention can approximately be made as determined by a design value.

As a result, the insulation of neutral point terminal 50# can be provided in a more reliable manner. It is thereby possible to improve workability and reduce variations in ensured insulation distance, when compared with the insulating structure shown in the non-patent document 1 described above. Therefore, the size of insulating cover 100# can be designed as small as possible in accordance with a required insulation distance determined by JIS and others. The production cost of insulating cover 100# can thereby be reduced.

Although not shown, it may be adopt a structure in which a fixing jig is further used to fix neutral point terminal 50# and insulating cover 100# in order to fix neutral point terminal 50# to insulating cover 100# more firmly. By forming insulating sheet 100 out of a flexible member (a typical example of which is a self-welding silicon sheet), stress applied to neutral point terminal 50# during assembly work is relieved. Accordingly, it is also possible to expect the effect of preventing a portion of each of the coil windings adjacent to the neutral point from being damaged.

As shown in FIG. 5, it is also possible to Form a bag-shaped insulating cover 150# by providing a fastening point 151 at one and of a silicon-based or fluorine-based, tube-like insulator 150. Fastening point 151 may also be provided in a contiguous manner at one end of the bag shape to occupy the entire circumference thereof.

Insulating cover 150# shown in FIG. 5 can also be used for insulation of the neutral point according to the embodiment of the present invention, as insulating cover 100# shown in FIG. 3. Fastening point 151 can be implemented by vibration welding provided by application of an ultrasonic wave and others.

As to the insulating cover used for the insulation of the neutral point according to the embodiment of the present invention, any material and shape can be used as long as the insulating cover is made of an insulator and has a shape allowing the inserted neutral point terminal to be fitted thereinto.

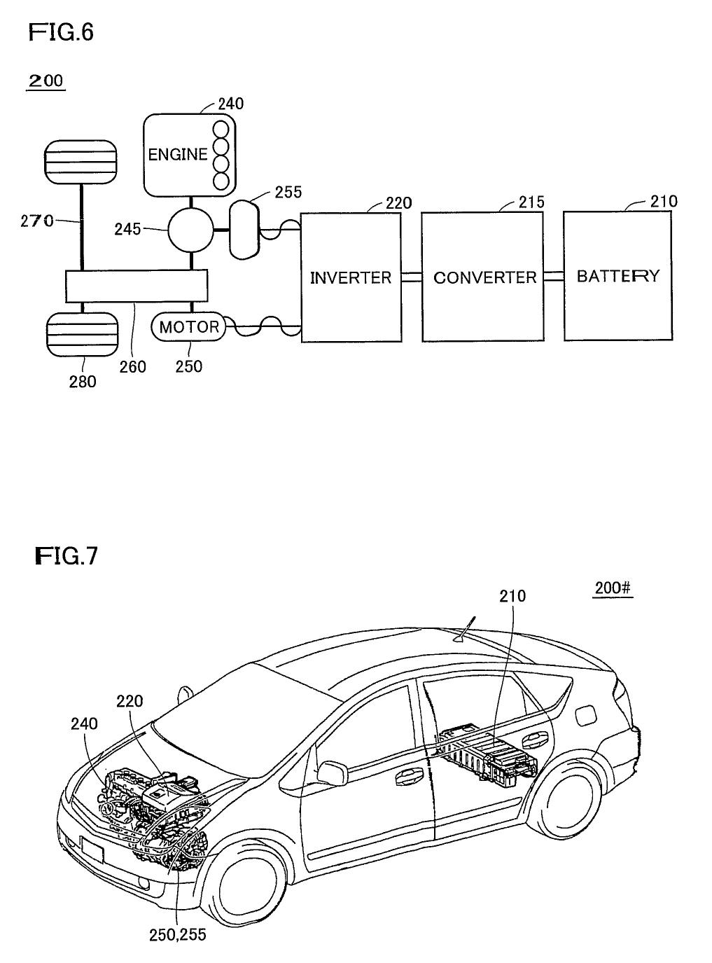

A configuration of a hybrid vehicle suitable for mounting an alternating-current motor having the insulating structure for the neutral point according to the embodiment of the present invention will hereinafter be described with reference to FIGS. 6 and 7.

Referring to FIG. 6, a hybrid system 200 that generates a vehicle driving force for the hybrid vehicle includes, in addition to an engine 240 serving as an internal combustion engine, a battery 210, a converter 215, an inverter 220, a power split device 245, a motor 250, a generator 255, a reduction gear 260, a driving shaft 270, and a driving wheel 280.

Battery 210 is formed of a rechargeable secondary battery (e.g. a lithium-ion secondary battery, a nickel metal hydride secondary battery and others). Converter 215 boosts a DC voltage supplied by battery 210. Inverter 220, which corresponds to three-phase inverter 20 in FIG. 1, converts an output voltage obtained from converter 215 into an AC voltage for driving motor 250. By arranging converter 215 that provides level conversion of the DC voltage, it is possible to drive motor 250 with an AC voltage having a higher-voltage amplitude when compared with the voltage supplied by battery 210, which can improve efficiency in driving of the motor.

Each of converter 215 and inverter 220 is formed such that bidirectional electric power conversion can be provided, and also has a function of converting electric power (AC voltage) generated by a regenerative braking operation of motor 250 and electric power (AC voltage) generated by generator 255 into a DC voltage for charging battery 210.

The form of engine 240 is not particularly limited, and an output generated by fuel combustion is input to power split device 245. Power split device 245 can divide a driving force obtained by engine 240 to output to a path that transmits the same to driving shaft 270 of driving wheel 280 through reduction gear 260, and a path that transmits the same to generator 255.

Generator 255 is rotated by the driving force, which is obtained from engine 240 and transmitted through power split device 245, to generate electric power. The electric power generated by generator 255 is used as electric power for charging battery 210, by converter 215 and inverter 220, or as electric power for driving motor 250.

Motor 250 is driven by the AC voltage supplied from inverter 220 to be rotated, and its driving force is transmitted to driving shaft 270 through reduction gear 260 to serve as a vehicle driving force.

Hybrid system 200 generates a vehicle driving force by a combination of a driving force generated by engine 240 and a driving force generated by motor 250 that uses an electric energy as a source. Accordingly, it is possible to output a total driving force required of the vehicle with an operating point of engine 240 limited within a high-efficiency operating range. Furthermore, electric power, which is recovered by regenerative power generation by motor 250 during deceleration of the vehicle and others, can be used to charge battery 210 that serves as a driving source of motor 250. Therefore, by appropriately controlling the operations of engine 240 and motor 250 in accordance with operational circumstances, fuel efficiency can be improved in hybrid system 200.

FIG. 7 shows an example of how main components of hybrid system 200 shown in FIG. 6 are arranged when being mounted on the hybrid vehicle.

Referring to FIG. 7, the insulation of the neutral point according to the embodiment of the present invention is applied to motor 250 and generator 255, each of which serves as an alternating-current rotary electric machine. It is necessary for motor 250 and generator 255 to be mounted, along with engine 240, in a relatively small space that makes assembly work difficult. Furthermore, motor 250 and generator 255 are positioned adjacently to engine 240, and hence affected by high temperature and vibrations.

Accordingly, by adopting the neutral point insulation according to the embodiment of the present invention, it is possible to improve workability of the assembly work allowing an alternating-current rotary electric machine (motor 250, generator 255) to be assembled in a space subject to arrangement constraints, and reduce variations in insulation distance of the neutral point after the assembly work. It is therefore possible to reliably insulate a neutral point of an alternating-current rotary electric machine even under a hostile environment caused by vibrations, heat and others.

As such, the insulating structure for the neutral point according to the embodiment of the present invention is suitable for an alternating-current rotary electric machine used as a vehicle driving motor for a hybrid vehicle and others.

Although the present invention has been described and illustrated in detail, it is clearly understood that the same is by way of illustration and example only and is not to be taken by way of limitation, the spirit and scope of the present invention being limited only by the terms of the appended claims.

1. A stator of an alternating-current rotary electric machine, comprising:
a plurality of phases of stator windings;
a neutral point terminal formed by electrically connecting one ends of the plurality of phases of said stator windings with each other; and
an insulating cover ensuring insulation of said neutral point terminal,
said insulating cover being provided with an opening allowing said neutral point terminal to be inserted therethrough, and being formed of an insulator processed into a bag shape allowing said neutral point terminal inserted through said opening to be fitted thereinto.

2. The stator of the alternating-current rotary electric machine according to claim 1, wherein a size and a shape of said insulating cover are designed such that a distance between the neutral point terminal in a fitted state and an end of said insulating cover is ensured to be at least a prescribed insulation distance.

3. The stator of the alternating-current rotary electric machine according to claim 1, wherein said insulating cover is formed by partially fastening a tube-like, self-welding insulating sheet to itself.

4. A method of insulating a plurality of phases of stator windings of a rotary electric machine, comprising the steps of:
processing an insulator into a bag shape to fabricate an insulating cover; and
inserting a neutral point terminal formed by electrically connecting one ends of the plurality of phases of said stator windings with each other, through an opening of said insulating cover, and fitting said inserted neutral point terminal thereinto for assembly.

5. The stator of the alternating-current rotary electric machine according to claim 2, wherein said insulating cover is formed by partially fastening a tube-like, self-welding insulating sheet to itself.
